(19) United States
(12) Patent Application Publication
(10) Pub. No.: US 2022/0009195 A1
(43) Pub. Date: Jan. 13, 2022

(54) BREATHABLE GEOSYNTHETIC CLAY LINER AND PRODUCTION PROCESS THEREFOR

(71) Applicants: BEIJING RECHSAND SCIENCE & TECHNOLOGY GROUP CO., LTD., BEIJING (CN); RENCHSAND ECO-ENVIRONMENT PROTECTION SCIENCE AND TECHNOLOGY CO., LTD., Anqing (CN)

(72) Inventors: Shengyi QIN, Beijing (CN); Zhikun MA, Beijing (CN); Wenxing HU, Beijing (CN)

(21) Appl. No.: 17/366,323

(22) Filed: Jul. 2, 2021

Related U.S. Application Data
(63) Continuation of application No. PCT/CN2020/070060, filed on Jan. 2, 2020.

(30) Foreign Application Priority Data
Jan. 2, 2019 (CN) 201910002398.5

(51) Int. Cl. B32B 5/16; B32B 7/12; B32B 7/09; B32B 5/24; B32B 5/30; B32B 27/06; B32B 37/12; B32B 38/04

(52) U.S. Cl. CPC B32B 5/16; B32B 7/12; B32B 7/09; B32B 5/24; B32B 5/30; B32B 27/06; E02B 3/122; B32B 38/04; B32B 2038/042; B32B 2262/08; B32B 2264/12; B32B 2307/724; B32B 2307/73; B32B 37/12

(57) ABSTRACT

The present application relates to the technical field of ecological environment remediation, and in particular to a breathable geosynthetic clay liner and a production process therefor. The breathable geosynthetic clay liner of the present application includes an upper breathable layer, a lower breathable layer, and a breathable and impermeable sand layer sandwiched between the upper breathable layer and the lower breathable layer; and the breathable and impermeable sand layer includes breathable and impermeable particles and expansive particles. The breathable geosynthetic clay liner of the present application is convenient to construct, high in production efficiency, and free of dust during a construction process.

### CROSS REFERENCE TO RELATED APPLICATIONS

This application is a continuation of International Patent Application No. PCT/CN2020/070060 with a filing date of Jan. 2, 2020, designating the United States, now pending, and further claims priority to Chinese Patent Application No. 201910002398.5, filed on Jan. 2, 2019, the entire content of which is incorporated herein by reference.

### TECHNICAL FIELD

The present application relates to the technical field of ecological environment restoration, in particular to a breathable geosynthetic clay and production process thereof.

### BACKGROUND

Water resources are particularly scarce in China, with a total amount of 28 trillion cubic meters, and per capita water resources of only 2,170 cubic meters, which is less than a quarter of the world average level. China is one of the 13 water-poor countries in the world. In China, the available water sources mainly include river water, freshwater lake water and shallow groundwater. For surface freshwater resources such as rivers and lakes, water loss is mainly due to evaporation and seepage. According to incomplete statistics, seepage accounts for about 80% of the water loss.

In order to solve the seepage problem of surface freshwater resources such as lakes, an anti-seepage layer is mainly used in the prior art, and the anti-seepage layer is a structural layer formed by treating anti-seepage materials at the bottom of an artificial lake. In a newly excavated artificial lake, water will leak due to the loose soil structure at the bottom of the lake. In order to prevent water from seepage, an anti-seepage layer structure is usually provided in the design drawing. Anti-seepage treatment can effectively control the seepage of the lake water, thus greatly reducing the loss of water. At present, geomembrane anti-seepage technology, mixed material anti-seepage technology and bentonite anti-seepage technology are mainly used.

However, the above three anti-seepage technologies mainly focus on the anti-seepage performance of the materials, but do not have too many requirements for the air permeability of the anti-seepage materials. In the prior art, a geosynthetic clay is filled with soil, which is not breathable and becomes viscous when meeting water. However, if the vertical communication between the earth and the air is blocked for a long time, oxygen content in the water body will decrease, and the self-purification function of the water body will also decrease, resulting in water quality deterioration. In order to solve the problem of difficulty in breathing while preventing seepage, the prior art CN103174107A discloses a breathable and impermeable bag for preventing seepage at the bottom of a river channel. The breathable and impermeable bag is composed of a breathable wall bag and breathable and impermeable particles filled therein. The breathable and impermeable bag has both anti-seepage performance and air permeability. However, due to good fluidity of the breathable and impermeable particles, they are easy to leak, and are inconvenient for construction. In addition, there is a lot of dust during the construction process, thus many inconveniences are caused to construction workers.

### SUMMARY

The purpose of the present application is to solve the problems in the prior art that the breathable and impermeable particles are easy to leak, and a lot of dust are generated during the construction process, and further to provide a breathable geosynthetic clay liner with convenient construction, high production efficiency, no dust during the construction process, and good air permeability and anti-seepage performance and a production process thereof.

In order to achieve the above purpose, the present application adopts the following technical solutions:

A breathable geosynthetic clay liner, comprises an upper breathable layer, a lower breathable layer, and a breathable and impermeable sand layer sandwiched between the upper breathable layer and the lower breathable layer;

the breathable and impermeable sand layer comprises a breathable and impermeable particle and an expansive particle, and the expansive particle is added in an amount of 0.1% to 1000% of the mass of the breathable and impermeable particle.

Preferably, the expansive particle has a particle size of 0.001 mm-5 mm.

Preferably, the expansive particle has a particle size of 0.075 mm-5 mm.

The expansive particle is added in an amount of 5%-200% of the mass of the breathable and impermeable particle.

Preferably, the expansive particle is a mixture of a first expansive particle having a particle size of 0.048 mm-0.075 mm and a second expansive particle having a particle size of 2.8 mm-4 mm.

Preferably, the expansive particle is at least one of bentonite and clay.

Preferably, the expansive particle is a mixture of the bentonite and the clay, and the mass ratio of the bentonite to the clay is 1:0.1-200.

Preferably, the breathable and impermeable particle comprises an aggregate and a hydrophobic film covering the aggregate.

The breathable and impermeable sand layer has a thickness of 1-30 mm.

The breathable and impermeable particle has a particle size of 0.045 mm-1 mm.

The hydrophobic film is present in an amount of 0.005-10 wt % of the aggregate.

Preferably, the hydrophobic film is a hydrophobic organic film, and the hydrophobic organic film is a film formed of one or more of a hydrophobic organic material selected from one or more of a hydrophobic epoxy resin, a hydrophobic phenolic resin, a hydrophobic polyurethane resin, a hydrophobic silicone resin, paraffin wax, and silane.

Preferably, the hydrophobic epoxy resin is one or more of a glycidyl ether epoxy resin, a glycidyl ester epoxy resin, a glycidyl amine epoxy resin, a linear aliphatic epoxy resin, a alicyclic epoxy resin, a polysulfide rubber modified epoxy resin, a polyamide resin modified epoxy resin, a polyvinyl tert-butyraldehyde modified epoxy resin, a nitrile rubber modified epoxy resin, a phenolic resin modified epoxy resin, a polyester resin modified epoxy resin, an urea melamine resin modified epoxy resin, a furfural resin modified epoxy resin, a vinyl resin modified epoxy resin, isocyanate modified epoxy resin, and silicone resin modified epoxy resin.

The hydrophobic phenolic resin is one or more of a xylene modified phenolic resin, an epoxy resin modified phenolic resin and a silicone modified phenolic resin.

Preferably, a curing agent is added to the hydrophobic organic film, and different curing agents are added to different organic materials, wherein:

for glycidyl ether epoxy resins, glycidyl ester epoxy resins, glycidyl amine epoxy resins, linear aliphatic epoxy resins, and alicyclic epoxy resins, polysulfide rubber modified epoxy resins, polyamide resin modified epoxy resins, polyvinyl tert-butyraldehyde modified epoxy resins, nitrile rubber modified epoxy resins, phenolic resin modified epoxy resins, polyester resin modified epoxy resins, urea melamine resin modified epoxy resins, furfural resin modified epoxy resins, vinyl resin modified epoxy resins, isocyanate modified epoxy resins, and silicone resin modified epoxy resins, the curing agent added therein in one or more of aliphatic amine, alicyclic amine, aromatic amine, polyamide, acid anhydride, and tertiary amine;

for xylene modified phenolic resins, epoxy resin modified phenolic resins and silicone modified phenolic resins, the curing agent added therein is hexamethylenetetramine;

for silicone resin, the curing agent is one or more of dibutyl tin dilaurate or N, N, N′, N′-tetramethyl guanidine salt;

for hydrophobic polyurethane resins, the curing agent is the adduct of TDI and TMP, a prepolymer of TDI and hydroxyl-containing component, and a trimer of one-component moisture curing agent and TDI; and

for unsaturated polyesters, the curing agents added at room temperature are ketone peroxides and cobalt naphthenates; the curing agent added during heating is one or more of tert-butyl peroxybenzoates, peroxydicarbonates, dialkyl peroxides, tert-hexyl peroxy octanoate and diester peroxydicarbonate.

Preferably, the aggregate is selected from one or more of quartz sand, slag, ceramsite, glass bead, medical stone, volcanic rock, kaolin, and graphite.

Preferably, the aggregate is medical stone, volcanic rock and kaolin in a mass ratio of 1:5-20:5-20.

Preferably, the breathable and impermeable particle is prepared by a method comprising the following steps:

1) heating the aggregate to a temperature of 50° C. to 400° C.;

2) adding the hydrophobic organic material and stirring evenly to make the aggregate coated on its surface to obtain a coated particle;

3) cooling, crushing, and sieving to obtain the breathable and impermeable particle.

Preferably, the step 2) further comprises a step of adding the expansive particle to the coated particle, and the expansive particle is at least one of bentonite and clay.

Preferably, the expansive particle is in an amount of 1-20% of the weight of the aggregate.

Preferably, the expansive particle has a particle size of 0.001 mm-5 mm.

Preferably, the upper air-permeable layer and/or the lower air-permeable layer are made of one or more materials selected from polyester fiber, polyethylene, polypropylene, polylactic acid, polycaprolactone, polyurethane, polyvinyl acetal, cellulose triacetate, glass fiber, and polytetrafluoroethylene.

Preferably, the upper breathable layer and the lower breathable layer are provided with a plurality of connection points, and the upper breathable layer and the lower breathable layer are connected by fiber at each connection point.

Preferably, the upper breathable layer is an upper breathable fiber cloth layer, and the lower breathable layer is a lower breathable fiber cloth layer.

The breathable fiber cloth mentioned in the present application is a hydrophobic breathable fiber cloth.

Preferably, the upper breathable layer and/or the lower breathable layer are breathable mesh structures.

Preferably, the upper breathable layer is a breathable fiber cloth layer, and the lower breathable layer is a woven cloth layer or a non-woven fabric layer.

The present application also provides a production process of the above-mentioned breathable geosynthetic clay liner, comprises the following steps:

1) laying a lower breathable layer;

2) laying a mixture of a breathable and impermeable particle and an expansive particle on the lower breathable layer, and scraping the mixture with a scraper to form a breathable and impermeable sand layer on the surface of the lower breathable layer;

3) laying an upper breathable layer on the breathable and impermeable sand layer;

4) fixedly connecting the upper breathable layer, the breathable and impermeable sand layer and the lower breathable layer through needle punching to form an integral body, thus obtaining a breathable geosynthetic clay liner.

Preferably, an adhesive layer is coated on the surface of the lower breathable layer.

Preferably, the adhesive layer is environment-friendly glue.

Preferably, the environment-friendly glue is one of acrylic resins and waterborne epoxy resins.

Preferably, the upper breathable layer is a breathable fiber cloth layer, the lower breathable layer is a woven cloth layer or a non-woven fabric layer; and the adhesive layer is environment-friendly glue.

Preferably, in the step 1), the adhesive layer is coated on a rotating roller, and then the lower breathable layer is laid on the rotating roller and transported forward with the rotating roller, so that the adhesive layer is coated on a lower surface of the lower breathable layer.

Preferably, the step 2) is: laying a mixture of a breathable and impermeable particle and an expansive particle on an upper surface of the lower breathable layer through a funnel arranged above the lower breathable layer, and scraping the mixture with a scraper to form a breathable and impermeable sand layer on the surface of the lower breathable layer.

Preferably, in the step 4), the upper breathable layer, the breathable and impermeable sand layer and the lower breathable layer are fixedly connected through needle punching with a hydrophobic thread to form an integral body, thus obtaining a breathable geosynthetic clay liner.

Preferably, the breathable and impermeable sand layer has a thickness of 1-30 mm. In the embodiments of the present application, the breathable and impermeable sand layer has a thickness of 3 mm, 6 mm or 9 mm.

Preferably, in the step 4), the fiber of the upper breathable layer is brought to the lower breathable layer through needle punching, and fixed into the lower breathable layer.

Preferably, in the step 4), the fiber of the upper breathable layer is brought to the lower breathable layer through needle punching, and fixed by the adhesive layer coated on the lower breathable layer. The needle used in the needle punching has a diameter of 0.3-0.5 mm, and the distance between two adjacent needles is 0.8-1.2 mm.

Preferably, a wool layer is laid on the surface of the upper breathable layer and/or the lower breathable layer.

Preferably, the wool layer may be woven from one or two of animal fur and chemical fibers.

Preferably, the chemical fiber is one or more of acrylic fiber, polyester fiber, and persian fiber.

The breathable geosynthetic clay liner described in the present application can also be bonded and fixed with the upper breathable layer, the lower breathable layer and the breathable and impermeable sand layer by welding.

The present application has achieved the following beneficial effects:

1) The breathable geosynthetic clay liner described in the present application has convenient construction, high production efficiency, and there is no dust during the construction process. Further, it has finer particles, controllable and less consumption, and low cost. The expansive particle is added in an amount of 0.1% to 1000% of the mass of the breathable and impermeable particles. Under this proportion, the breathable geosynthetic clay liner has better air permeability and better anti-seepage performance.

Expansive particles are added to the breathable and impermeable sand layer, so as to provide better gaps between the sand particles, meanwhile the amount of breathable and impermeable particles is reduced. Further, the adding of expansive particles enhances the hydrophobic function of the breathable and impermeable sand layer, and avoids uneven settlement of particles in the breathable and impermeable sand layer, which is more conducive to construction. Meanwhile, the durability and air permeability of the breathable geosynthetic clay liner are improved. In addition, the adding of expansive particles can also reduce the thickness of the breathable and impermeable sand layer, thereby reducing the cost.

2) Preferably, the expansive particle is added in an amount of 5%-200% of the mass of the breathable and impermeable particle in the present application. Under this proportion, the breathable geosynthetic clay liner has better air permeability and better anti-seepage performance.

3) Preferably, bentonite and clay are added to the breathable and impermeable particles. When the mass ratio of the bentonite to the clay is 1:0.1-200, the breathable geosynthetic clay liner has better air permeability and waterproof performance.

4) Preferably, in the production process of the breathable geosynthetic clay liner of the present application, it is unexpectedly found that adding expandable particles can improve the breathability and waterproof performance of the breathable geosynthetic clay liner.

5) The production process of the breathable geosynthetic clay liner described in the present application is simple, and the upper breathable layer and lower breathable layer are connected through needle punching process, which solves the problems that the breathable and impermeable particles are difficult to construct, and there is a lot of dust during the construction process. The thickness of the breathable and impermeable sand layer in the present application can be adjusted by a scraper, and the thickness of the breathable and impermeable sand layer is the same as that of the scraper. In the present application, the thickness of the air permeable and impermeable sand layer is limited to 1-30 mm, and the breathable and impermeable sand layer in the upper breathable layer and the lower breathable layer should not be too thick, which may easily cause the final coil to be unable to roll.

The needle in the needle punching described in the present application is provided with hangnails, and the needle plate moves vertically downwards to bring fibers in the upper breathable layer to the lower breathable layer and fix them with an environmental-friendly glue coated on a surface of the lower breathable layer. Meanwhile, when the needle plate moves upwards, the fibers in the lower breathable layer are brought to the upper breathable layer to connect of the fibers in the upper breathable layer and lower breathable layer, and to firmly fix the particles in the breathable and impermeable sand layer in the middle, thus reducing the fluidity of the particles in the breathable and impermeable sand layer. The frequency of inserting needle described in the present application can be adjusted according to the movement speed of the rotating roller below the lower breathable layer. The wool layer described in the present application can act as a reinforcing rib to further increase the strength of the breathable layer. Meanwhile, the hangnails on the needle can hook the fibers in the wool layer to connect the upper breathable layer and lower breathable layer and further fix the particles in the breathable and impermeable sand layer.

6) The breathable geosynthetic clay liner described in the present application has excellent waterproof performance and breathability, and can be widely used in fields such as land restoration, river regulation, lake regulation, roof seepage control of houses, desert farming, waterproofing of farmland or land.

### BRIEF DESCRIPTION OF THE DRAWINGS

In order to make the technical solution of the present application more clear, drawings to be used in embodiments will be described briefly hereinafter. Obviously, drawings used in the following description are merely some embodiments of the present application. Those skilled in the art also can conclude other drawings based on these drawings without paying creative work.

FIG. 1 is a schematic diagram of the production process of the breathable geosynthetic clay liner, and the reference numbers are as follows:

1. lower breathable fiber cloth layer, 2. upper breathable fiber cloth layer, 3. funnel, 4. scraper, 5. needle plate, 6. rotating roller, 7. breathable and impermeable sand layer.

### DETAILED DESCRIPTION OF EMBODIMENTS

The following embodiments are provided for better understanding of the present application, which are not limited to the best embodiment, and do not means to limit the content and protection scope of the present application. Any product identical or similar to the present application obtained by combining the features of other prior art and those of the present application shall fall within the protection scope of the present application.

If specific experimental steps or conditions are not specified in the embodiments, it can be carried out according to the conventional experimental steps described in the prior art. The reagents or instruments used without indicating the manufacturers are all conventional reagent products that are commercially available.

### Embodiment 1

The present embodiment provides a breathable geosynthetic clay liner, which comprises an upper breathable layer, a lower breathable layer, and a breathable and impermeable sand layer sandwiched between the upper breathable layer and the lower breathable layer. The upper breathable layer is an upper breathable fiber cloth layer, and the lower breathable layer is a lower breathable fiber cloth layer. The breathable and impermeable sand layer comprises a breathable and impermeable particle and an expansive particle, and the expansive particle is added in an amount of 0.1% of the mass of the breathable and impermeable particle. The breathable and impermeable particle has a particle size of 1 mm; and the expansive particle is bentonite having a particle size of 5 mm.

The breathable and impermeable particle comprises an aggregate such as quartz sand and a polyvinyl tert-butyraldehyde modified epoxy resin covering the aggregate. The polyvinyl tert-butyraldehyde modified epoxy resin is 0.005 wt % of the mass of the quartz sand.

The breathable and impermeable particle is prepared by a method comprising the following steps:

1) heating quartz sand particles to a temperature of 50° C.;

2) adding liquid polyvinyl tert-butyraldehyde modified epoxy resin, stirring thoroughly, then adding polyamide curing agent (accounting for 0.015 wt % of the quartz sand), and stirring evenly, so that the epoxy resin is coated on the surface of the quartz sand particles, thus obtaining coated particles; followed by cooling, crushing and sieving to obtain breathable and impermeable particles.

The production process of the above-mentioned breathable geosynthetic clay liner comprises the following steps:

1) coating acrylic resin on a rotating roller 6, and a lower breathable layer 1 is laid on the rotating roller 6 and transported forward with the rotating roller 6, so that the acrylic resin is coated on a lower surface of the lower breathable layer ;

2) laying a mixture of a breathable and impermeable particle and an expansive particle on an upper surface of the lower breathable fiber cloth layer 1 through a funnel 3 provided above the lower breathable fiber cloth layer 1, and scraping the mixture with a scraper 4 to form a breathable and impermeable sand layer 7 with a thickness of 1 mm;

3) laying an upper breathable fiber cloth layer 2 on the breathable and impermeable sand layer 7; and

4) fixedly connecting the upper breathable fiber cloth layer 2, the breathable and impermeable sand layer 7 and the lower breathable fiber cloth layer 1 through needle punching by using a needle on the needle plate 5 to form an integral body, wherein, the needle has a diameter of 0.3 mm, and the distance between two adjacent needles is 0.8 mm; specifically, the upper breathable fiber cloth layer and lower breathable fiber cloth layer are penetrated by a needle installed on the needle plate 5, the needle is provided with hangnails, and the needle plate 5 moves vertically downwards to bring fibers of the upper breathable fiber cloth layer 2 to the lower breathable fiber cloth layer 1 and fix them with an environmental-friendly glue coated on a surface of the lower breathable fiber cloth layer 1, meanwhile, when the needle plate 5 moves upwards, fibers of the lower breathable fiber cloth layer 1 are brought to the upper breathable fiber cloth layer 2 to realize the connection of the fibers of the upper breathable fiber cloth layer and lower breathable fiber cloth layer, thus firmly fixing the particles in the breathable and impermeable sand layer 7 thereof, and reducing the fluidity to obtain a breathable geosynthetic clay liner.

### Embodiment 2

The present embodiment provides a breathable geosynthetic clay liner, which comprises an upper breathable layer, a lower breathable layer, and a breathable and impermeable sand layer sandwiched between the upper breathable layer and the lower breathable layer. The upper breathable layer is an upper breathable fiber cloth layer, and the lower breathable layer is a lower woven fabric. The breathable and impermeable sand layer comprises a breathable and impermeable particle and an expansive particle, and the expansive particle is added in an amount of 1000% of the mass of the breathable and impermeable particle. The breathable and impermeable particle has a particle size of 0.045 mm; and the expansive particle is clay having a particle size of 0.001 mm.

The breathable and impermeable particle comprises an aggregate such as quartz sand and a polyamide resin modified epoxy resin covering the aggregate. The polyamide resin modified epoxy resin is 10 wt % of the mass of the quartz sand.

The polyamide resin modified epoxy resin accounts for 10 wt % of the mass of the quartz sand.

The breathable and impermeable particle is prepared by a method comprising the following steps:

1) heating quartz sand particles to a temperature of 400° C.;

2) adding polyamide resin modified epoxy resin, stirring thoroughly, then adding alicyclic amine curing agent (accounting for 0.015 wt % of the quartz sand), and stirring evenly, so that the epoxy resin is coated on the surface of the quartz sand particles, thus obtaining coated particles; followed by cooling, crushing and sieving to obtain breathable and impermeable particles.

The production process of the above-mentioned breathable geosynthetic clay liner comprises the following steps:

1) coating waterborne epoxy resin on a rotating roller 6, and a lower woven cloth is laid on the rotating roller 6 and transported forward with the rotating roller 6, so that the waterborne epoxy resin is coated on a lower surface of the lower woven cloth;

2) laying a mixture of a breathable and impermeable particle and an expansive particle on an upper surface of the lower woven cloth through a funnel 3 provided above the lower woven cloth, and scraping the mixture with a scraper 4 to form a breathable and impermeable sand layer 7 with a thickness of 30 mm;

3) laying an upper breathable fiber cloth layer 2 on the breathable and impermeable sand layer 7; and

4) fixedly connecting the upper breathable fiber cloth layer 2, the breathable and impermeable sand layer 7 and the lower woven cloth through needle punching by using a needle on the needle plate 5 to form an integral body, wherein, the needle has a diameter of 0.5 mm, and the distance between two adjacent needles is 1.2 mm; specifically, the upper breathable fiber cloth layer 2 and the lower woven cloth are penetrated by a needle installed on the needle plate 5, the needle is provided with hangnails, and the needle plate 5 moves vertically downwards to bring fibers of the upper breathable fiber cloth layer 2 to the lower woven cloth and fix them with an environmental-friendly glue coated on a surface of the lower woven cloth, meanwhile, the needle plate 5 moves upwards, repeating for many times to realize the connection of the fibers in the upper breathable fiber cloth layer and lower woven cloth, thus firmly fixing the particles in the breathable and impermeable sand layer 7 thereof, and reducing the fluidity, to obtain a breathable geosynthetic clay liner.

### Embodiment 3

The present embodiment provides a breathable geosynthetic clay liner, which comprises an upper breathable layer, a lower breathable layer, and a breathable and impermeable sand layer sandwiched between the upper breathable layer and the lower breathable layer. The upper breathable layer is an upper breathable fiber cloth layer, and the lower breathable layer is a lower breathable fiber cloth layer. The breathable and impermeable sand layer comprises a breathable and impermeable particle and an expansive particle, and the expansive particle is added in an amount of 5% of the mass of the breathable and impermeable particle. The breathable and impermeable particle has a particle size of 0.1 mm; and the expansive particle is bentonite having a particle size of 0.075 mm.

The breathable and impermeable particle comprises an aggregate such as quartz sand and a polyamide resin modified epoxy resin covering the aggregate. The polyamide resin modified epoxy resin is 3 wt % of the mass of the quartz sand.

The breathable and impermeable particle is prepared by a method comprising the following steps:

1) heating quartz sand particles to a temperature of 70° C.;

2) adding polyamide resin modified epoxy resin, stirring thoroughly, then adding alicyclic amine curing agent (accounting for 0.015 wt % of the quartz sand), and stirring evenly, so that the epoxy resin is coated on the surface of the quartz sand particles, thus obtaining coated particles; followed by cooling, crushing and sieving, thus obtaining breathable and impermeable particles.

The production process of the above-mentioned breathable geosynthetic clay liner comprises the following steps:

1) coating waterborne epoxy resin on a rotating roller 6, and a lower breathable layer 1 is laid on the rotating roller 6 and transported forward with the rotating roller 6, so that the waterborne epoxy resin is coated on a lower surface of the lower breathable layer 1;

2) laying a mixture of a breathable and impermeable particle and an expansive particle on an upper surface of the lower breathable fiber cloth layer 1 through a funnel 3 provided above the lower breathable fiber cloth layer 1, and scraping the mixture with a scraper 4 to form a breathable and impermeable sand layer 7 with a thickness of 6 mm;

3) laying an upper breathable fiber cloth layer 2 on the breathable and impermeable sand layer 7; and

4) fixedly connecting the upper breathable fiber cloth layer 2, the breathable and impermeable sand layer 7 and the lower breathable fiber cloth layer 1 through needle punching by using a needle on the needle plate 5 to form an integral body, wherein, the needle has a diameter of 0.4 mm, and the distance between two adjacent needles is 1.0 mm, specifically, the upper breathable fiber cloth layer and lower breathable fiber cloth layer are penetrated by a needle installed on the needle plate 5.The needle is provided with hangnails, and the needle plate 5 moves vertically downwards to bring fibers of the upper breathable fiber cloth layer 2 to the lower breathable fiber cloth layer 1 and fix them with an environmental-friendly glue coated on a surface of the lower breathable fiber cloth layer 1, meanwhile, when the needle plate 5 moves upwards, fibers of the lower breathable fiber cloth layer 1 are brought to the upper breathable fiber cloth layer 2 to realize the connection of the fibers of the upper breathable fiber cloth layer and lower breathable fiber cloth layer, thus firmly fixing the particles in the breathable and impermeable sand layer 7 thereof, and reducing the fluidity, to obtain a breathable geosynthetic clay liner.

### Embodiment 4

When compared with Embodiment 3, the only difference of Embodiment 4 lies in that the expansive particle is added in an amount of 200% of the mass of the breathable and impermeable particle.

### Embodiment 5

When compared with Embodiment 3, the only difference of Embodiment 5 lies in that the expansive particle is a mixture of the bentonite and the clay (the mass ratio of the bentonite to the clay is 1:0.1), and the expansive particle has a particle size of 0.075 mm.

### Embodiment 6

When compared with Embodiment 3, the only difference of Embodiment 6 lies in that the expansive particle is a mixture of the bentonite and the clay (the mass ratio of the bentonite to the clay is 1:200), and the expansive particle has a particle size of 0.075 mm.

### Embodiment 7

When compared with Embodiment 3, the only difference of Embodiment 7 lies in that the expansive particle is a mixture of the bentonite and the clay (the mass ratio of the bentonite to the clay is 1:50), and the expansive particle has a particle size of 0.075 mm.

### Embodiment 8

The present embodiment provides a breathable geosynthetic clay liner, which comprises an upper breathable layer, a lower breathable layer, and a breathable and impermeable sand layer sandwiched between the upper breathable layer and the lower breathable layer. The upper breathable layer is an upper breathable fiber cloth layer, and the lower breathable layer is a lower breathable fiber cloth layer. The breathable and impermeable sand layer comprises a breathable and impermeable particle and an expansive particle, and the expansive particle is added in an amount of 5% of the mass of the breathable and impermeable particle. The breathable and impermeable particle has a particle size of 0.1 mm; and the expansive particle is clay having a particle size of 0.075 mm.

The breathable and impermeable particle comprises an aggregate and a polyamide resin modified epoxy resin covering the aggregate. The aggregate is a mixture of medical stone, volcanic rock and kaolin with a mass ratio of 1:5:20. The polyamide resin modified epoxy resin is 3 wt % of the mass of the aggregate.

The breathable and impermeable particle is prepared by a method comprising the following steps:

1) heating quartz sand particles to a temperature of 70° C.;

2) adding polyamide resin modified epoxy resin, stirring thoroughly, then adding alicyclic amine curing agent (accounting for 0.015 wt % of the aggregate), and stirring evenly, so that the epoxy resin is coated on the surface of the aggregate, thus obtaining coated particles; followed by cooling, crushing and sieving, to obtain a breathable and impermeable particle.

The production process of the above-mentioned breathable geosynthetic clay liner comprises the following steps:

1) coating waterborne epoxy resin on a rotating roller 6, and a lower breathable layer 1 is laid on the rotating roller 6 and transported forward with the rotating roller 6, so that the waterborne epoxy resin is coated on a lower surface of the lower breathable layer 1;

2) laying a mixture of a breathable and impermeable particle and an expansive particle on an upper surface of the lower breathable fiber cloth layer 1 through a funnel 3 provided above the lower breathable fiber cloth layer 1, and scraping the mixture with a scraper 4 to form a breathable and impermeable sand layer 7 with a thickness of 6 mm;

3) laying an upper breathable fiber cloth layer 2 on the breathable and impermeable sand layer 7; and

4) fixedly connecting the upper breathable fiber cloth layer 2, the breathable and impermeable sand layer 7 and the lower breathable fiber cloth layer 1 through needle punching by using a needle on the needle plate 5 to form an integral body, wherein, the needle has a diameter of 0.4 mm, and the distance between two adjacent needles is 1.0 mm; specifically, the upper breathable fiber cloth layer and lower breathable fiber cloth layer are penetrated by a needle installed on the needle plate 5, the needle is provided with hangnails, and the needle plate 5 moves vertically downwards to bring fibers in the upper breathable fiber cloth layer 2 to the lower breathable fiber cloth layer 1 and fix them with an environmental-friendly glue coated on a surface of the lower breathable fiber cloth layer 1, meanwhile, when the needle plate 5 moves upwards, fibers of the lower breathable fiber cloth layer 1 are brought to the upper breathable fiber cloth layer 2 to realize the connection of the fibers in the upper breathable fiber cloth layer and lower breathable fiber cloth layer, thus firmly fixing the particles in the breathable and impermeable sand layer 7 thereof, and reducing the fluidity, to obtain a breathable geosynthetic clay liner.

### Embodiment 9

When compared with Embodiment 3, the only difference of Embodiment 9 lies in that the mass ratio of medical stone, volcanic rock and kaolin is 1:5:20.

### Embodiment 10

The present embodiment provides a breathable geosynthetic clay liner, which comprises an upper breathable layer, a lower breathable layer, and a breathable and impermeable sand layer sandwiched between the upper breathable layer and the lower breathable layer. The upper breathable layer is an upper breathable fiber cloth layer, and the lower breathable layer is a lower breathable fiber cloth layer. The breathable and impermeable sand layer comprises a breathable and impermeable particle and an expansive particle, and the expansive particle is added in an amount of 5% of the mass of the breathable and impermeable particle. The breathable and impermeable particle has a particle size of 0.1 mm; and the expansive particle is bentonite having a particle size of 0.075 mm.

The breathable and impermeable particle comprises an aggregate and a polyamide resin modified epoxy resin covering the aggregate. The aggregate is quartz sand. The polyamide resin modified epoxy resin is 3 wt % of the mass of the quartz sand.

The breathable and impermeable particles contain aggregate and polyamide resin modified epoxy resin coated with the aggregate.

The breathable and impermeable particle is prepared by a method comprising the following steps:

1) heating quartz sand particles to a temperature of 70° C.;

2) adding polyamide resin modified epoxy resin, stirring thoroughly, then adding alicyclic amine curing agent (accounting for 0.015 wt % of the quartz sand), and stirring evenly, so that the epoxy resin is coated on the surface of the quartz sand particles, thus obtaining coated particles. Then adding bentonite (the bentonite has a particle size of 5 mm, and is added in an amount of 1 wt % of the mass of the quartz sand) into the coated particles, stirring evenly, then cooling, crushing and sieving to obtain a breathable and impermeable particle.

The production process of the above-mentioned breathable geosynthetic clay liner comprises the following steps:

1) coating waterborne epoxy resin on a rotating roller 6, and a lower breathable layer 1 is laid on the rotating roller 6 and transported forward with the rotating roller 6, so that the waterborne epoxy resin is coated on a lower surface of the lower breathable layer 1;

2) laying a mixture of a breathable and impermeable particle and an expansive particle on an upper surface of the lower breathable fiber cloth layer 1 through a funnel 3 provided above the lower breathable fiber cloth layer 1, and scraping the mixture with a scraper 4 to form a breathable and impermeable sand layer 7 with a thickness of 6 mm;

3) laying an upper breathable fiber cloth layer 2 on the breathable and impermeable sand layer 7; and

4) fixedly connecting the upper breathable fiber cloth layer 2, the breathable and impermeable sand layer 7 and the lower breathable fiber cloth layer 1 through needle punching by using a needle on the needle plate 5 to form an integral body, wherein, the needle has a diameter of 0.4 mm, and the distance between two adjacent needles is 1.0 mm; specifically, the upper breathable fiber cloth layer and lower breathable fiber cloth layer are penetrated by a needle installed on the needle plate 5, the needle is provided with hangnails, and the needle plate 5 moves vertically downwards to bring fibers of the upper breathable fiber cloth layer 2 to the lower breathable fiber cloth layer 1 and fix them with an environmental-friendly glue coated on a surface of the lower breathable fiber cloth layer 1, meanwhile, when the needle plate 5 moves upwards, fibers of the lower breathable fiber cloth layer 1 are brought to the upper breathable fiber cloth layer 2 to realize the connection of the fibers in the upper breathable fiber cloth layer and lower breathable fiber cloth layer, thus firmly fixing the particles in the breathable and impermeable sand layer 7 thereof, and reducing the fluidity, to obtain a breathable geosynthetic clay liner is obtained.

### Embodiment 11

The present embodiment provides a breathable geosynthetic clay liner, which comprises an upper breathable layer, a lower breathable layer, and a breathable and impermeable sand layer sandwiched between the upper breathable layer and the lower breathable layer. The upper breathable layer is an upper breathable fiber cloth layer, and the lower breathable layer is a lower breathable fiber cloth layer. The breathable and impermeable sand layer comprises a breathable and impermeable particle and an expansive particle, and the expansive particle is added in an amount of 5% of the mass of the breathable and impermeable particle. The breathable and impermeable particle has a particle size of 0.1 mm; and the expansive particle is bentonite having a particle size of 0.075 mm.

The breathable and impermeable particle comprises an aggregate and a polyamide resin modified epoxy resin covering the aggregate. The aggregate is quartz sand. The polyamide resin modified epoxy resin is 3 wt % of the mass of the quartz sand.

The breathable and impermeable particle is prepared by a method comprising the following steps:

1) heating quartz sand particles to a temperature of 70° C.;

2) adding polyamide resin modified epoxy resin, stirring thoroughly, then adding alicyclic amine curing agent (accounting for 0.015 wt % of the quartz sand), and stirring evenly, so that the epoxy resin is coated on the surface of the quartz sand particles, thus obtaining coated particles, then adding bentonite (the bentonite has a particle size of 0.001 mm, and is added in an amount of 20 wt % of the mass of the quartz sand) into the coated particles, stirring evenly, then cooling, crushing and sieving to obtain a breathable and impermeable particle.

The production process of the above-mentioned breathable geosynthetic clay liner comprises the following steps:

1) coating waterborne epoxy resin on a rotating roller 6, and a lower breathable layer 1 is laid on the rotating roller 6 and transported forward with the rotating roller 6, so that the waterborne epoxy resin is coated on a lower surface of the lower breathable layer 1;

2) laying a mixture of a breathable and impermeable particle and an expansive particle on an upper surface of the lower breathable fiber cloth layer 1 through a funnel 3 provided above the lower breathable fiber cloth layer 1, and scraping the mixture with a scraper 4 to form a breathable and impermeable sand layer 7 with a thickness of 6 mm;

3) laying an upper breathable fiber cloth layer 2 on the breathable and impermeable sand layer 7; and

4) fixedly connecting the upper breathable fiber cloth layer 2, the breathable and impermeable sand layer 7 and the lower breathable fiber cloth layer 1 through needle punching by using a needle on the needle plate 5 to form an integral body, wherein, the needle has a diameter of 0.4 mm, and the distance between two adjacent needles is 1.0 mm; specifically, the upper breathable fiber cloth layer and lower breathable fiber cloth layer are penetrated by a needle installed on the needle plate 5, the needle is provided with hangnails, and the needle plate 5 moves vertically downwards to bring fibers in the upper breathable fiber cloth layer 2 to the lower breathable fiber cloth layer 1 and fix them with an environmental-friendly glue coated on a surface of the lower breathable fiber cloth layer 1, meanwhile, when the needle plate 5 moves upwards, fibers of the lower breathable fiber cloth layer 1 are brought to the upper breathable fiber cloth layer 2 to realize the connection of the fibers in the upper breathable fiber cloth layer and lower breathable fiber cloth layer, thus firmly fixing the particles in the breathable and impermeable sand layer 7 thereof, and reducing the fluidity, to obtain a breathable geosynthetic clay liner.

### Embodiment 12

When compared with Embodiment 3, the only difference of Embodiment 12 lies in that the surface of the lower breathable fiber cloth layer is not coated with waterborne epoxy resin, and the fibers of the upper breathable fiber cloth layer are brought to the lower breathable fiber cloth layer through needle punching and are fixed into the lower breathable fiber cloth layer.

### Embodiment 13

When compared with Embodiment 3, the only difference of Embodiment 13 lies in that a wool layer is laid on the surface of the upper breathable fiber cloth layer.

### Embodiment 14

When compared with Embodiment 3, the only difference of Embodiment 14 lies in that the expansive particle is a mixture of a first bentonite particle having a particle size of 0.048 mm and a second bentonite particle having a particle size of 4 mm (the mass ratio of the first bentonite particle and the second bentonite particle is 1:1), and the breathable and impermeable sand layer has a thickness of 3 mm.

### Embodiment 15

When compared with Embodiment 3, the only difference of Embodiment 15 lies in that the expansive particle is a mixture of a first bentonite particle having a particle size of 0.075 mm and a second bentonite particle having a particle size of 2.8 mm (the mass ratio of the first bentonite particle and the second bentonite particle is 1:10), and the breathable and impermeable sand layer has a thickness of 9 mm.

### Embodiment 16

When compared with Embodiment 3, the only difference of Embodiment 16 lies in that the upper breathable layer is an upper breathable fiber cloth layer, and the lower breathable layer is a lower woven cloth.

### Embodiment 17

When compared with Embodiment 3, the only difference of Embodiment 17 lies in that the upper breathable layer is an upper breathable fiber cloth layer, and the lower breathable layer is a lower non-woven fabric.

### Embodiment 18

When compared with Embodiment 3, the only difference of Embodiment 18 lies in that in the step 4), the upper breathable fiber cloth layer, the breathable and impermeable sand layer and the lower breathable fiber cloth layer are fixedly connected through a conventional needle punching process with a hydrophobic thread to form an integral body, thus obtaining a breathable geosynthetic clay liner.

### Comparative Example 1

When compared with Embodiment 3, the only difference of Comparative example 1 lies in that the breathable and impermeable sand layer in this comparative example only uses expansive particles, and no breathable and impermeable particles are added.

### Test Example

The air permeability and waterproof performance of the breathable geosynthetic clay liner obtained in Embodiments 1-11 and Comparative Example 1 are tested, and the results are shown in table 1, so as to illustrate the hydrophobicity and air permeability of the breathable geosynthetic clay liner in the present application.

The principle of the air permeability detection method is to test by using a differential-pressure method, a certain gas pressure difference (1 kpa) is maintained on both sides of the sample at room temperature, and the air permeability is calculated by measuring the change in the gas pressure on the low pressure side of the sample. As for the method of measuring the water blocking height, please see patent CN102890046A, which discloses a device and a method for detecting anti-seepage performance of anti-seepage sand.

| | Air permeability | Water blocking |
|---|---|---|
| | performance (l/min) | height (cm) |
| Example 1 | 0.545 | 34 |
| Example 2 | 0.499 | 32 |
| Example 3 | 0.510 | 39 |
| Example 4 | 0.507 | 37 |
| Example 5 | 0.537 | 48 |
| Example 6 | 0.526 | 45 |
| Example 7 | 0.528 | 46 |
| Example 8 | 0.522 | 45 |
| Example 9 | 0.527 | 48 |
| Example 10 | 0.514 | 43 |
| Example 11 | 0.512 | 42 |
| Comparative example 1 | 0.464 | 29 |

Apparently, the aforementioned embodiments are merely examples illustrated for clearly describing the present application, rather than limiting the implementation ways thereof. For those skilled in the art, various changes and modifications in other different forms can be made on the basis of the aforementioned description. It is unnecessary and impossible to exhaustively list all the implementation ways herein. However, any obvious changes or modifications derived from the aforementioned description are intended to be embraced within the protection scope of the present application.

1. A breathable geosynthetic clay liner, comprising an upper breathable layer, a lower breathable layer, and a breathable and impermeable sand layer sandwiched between the upper breathable layer and the lower breathable layer;
the breathable and impermeable sand layer comprises a breathable and impermeable particle and an expansive particle, and the expansive particle is added in an amount of 0.1% to 1000% of the mass of the breathable and impermeable particle.

2. The breathable geosynthetic clay liner of claim 1, wherein the expansive particle has a particle size of 0.001 mm-5 mm, preferably 0.075 mm-5 mm;
the expansive particle is added in an amount of 5%-200% of the mass of the breathable and impermeable particle;
preferably, the expansive particle is a mixture of a first expansive particle having a particle size of 0.048 mm-0.075 mm and a second expansive particle having a particle size of 2.8 mm-4 mm.

3. The breathable geosynthetic clay liner of claim 1, wherein the expansive particle is at least one of bentonite and clay;
preferably, the expansive particle is a mixture of the bentonite and the clay, and the mass ratio of the bentonite to the clay is 1:0.1-200.

4. The breathable geosynthetic clay liner of claim 1, wherein the breathable and impermeable particle comprises an aggregate and a hydrophobic film covering the aggregate;
the hydrophobic film is present in an amount of 0.005-10 wt % of the aggregate;
the breathable and impermeable sand layer has a thickness of 1-30 mm;
the breathable and impermeable particle has a particle size of 0.045 mm-1 mm.

5. The breathable geosynthetic clay liner of claim 4, wherein the hydrophobic film is a hydrophobic organic film, and the hydrophobic organic film is a film formed of one or more of a hydrophobic organic material selected from one or more of a hydrophobic epoxy resin, a hydrophobic phenolic resin, a hydrophobic polyurethane resin, a hydrophobic silicone resin, paraffin wax, and silane;
preferably, the hydrophobic epoxy resin is one or more of a glycidyl ether epoxy resin, a glycidyl ester epoxy resin, a glycidyl amine epoxy resin, a linear aliphatic epoxy resin, and a alicyclic epoxy resin, a polysulfide rubber modified epoxy resin, a polyamide resin modified epoxy resin, a polyvinyl tert-butyraldehyde modified epoxy resin, a nitrile rubber modified epoxy resin, a phenolic resin modified epoxy resin, a polyester resin modified epoxy resin, an urea melamine resin modified epoxy resin, a furfural resin modified epoxy resin, a vinyl resin modified epoxy resin, isocyanate modified epoxy resin, and silicone resin modified epoxy resin;
the hydrophobic phenolic resin is one or more of a xylene modified phenolic resin, an epoxy resin modified phenolic resin and a silicone modified phenolic resin.

6. The breathable geosynthetic clay liner of claim 4, wherein the aggregate is selected from one or more of quartz sand, slag, ceramsite, glass bead, medical stone, volcanic rock, kaolin, and graphite.

7. The breathable geosynthetic clay liner of claim 1, wherein the breathable and impermeable particle is prepared by a method comprising the following steps:
1) heating the aggregate to a temperature of 50° C. to 400° C.;
2) adding the hydrophobic organic material and stirring evenly to make the aggregate coated on its surface to obtain a coated particle;
3) cooling, crushing, and sieving to obtain the breathable and impermeable particle.

8. The breathable geosynthetic clay liner of claim 7, wherein the step 2) further comprises a step of adding the expansive particle to the coated particle, and the expansive particle is at least one of bentonite and clay;
the expansive particle is in an amount of 1-20% of the weight of the aggregate; and
the expansive particle has a particle size of 0.001 mm-5 mm.

9. The breathable geosynthetic clay liner of claim 1, wherein the upper breathable layer and/or the lower breathable layer are made of one or more materials selected from polyester fiber, polyethylene, polypropylene, polylactic acid PLA, polycaprolactone, polyurethane, polyvinyl acetal, cellulose triacetate, glass fiber, and polytetrafluoroethylene.

10. The breathable geosynthetic clay liner of claim 1, wherein the upper breathable layer and the lower breathable layer are provided with a plurality of connection points, and the upper breathable layer and the lower breathable layer are connected by fiber at each connection point.

11. The breathable geosynthetic clay liner of claim 2, wherein the expansive particle is at least one of bentonite and clay;
preferably, the expansive particle is a mixture of the bentonite and the clay, and the mass ratio of the bentonite to the clay is 1:0.1-200.

12. The breathable geosynthetic clay liner of claim 2, wherein the breathable and impermeable particle is prepared by a method comprising the following steps:
1) heating the aggregate to a temperature of 50° C. to 400° C.;
2) adding the hydrophobic organic material and stirring evenly to make the aggregate coated on its surface to obtain a coated particle;
3) cooling, crushing, and sieving to obtain the breathable and impermeable particle.

13. The breathable geosynthetic clay liner of claim 2, wherein the upper breathable layer and the lower breathable layer are provided with a plurality of connection points, and the upper breathable layer and the lower breathable layer are connected by fiber at each connection point.

14. A production process of the breathable geosynthetic clay liner of claim 1, comprising the following steps:
1) laying a lower breathable layer;
2) laying a mixture of a breathable and impermeable particle and an expansive particle on the lower breathable layer, and scraping the mixture with a scraper to form a breathable and impermeable sand layer on the surface of the lower breathable layer;
3) laying an upper breathable layer on the breathable and impermeable sand layer;
4) fixedly connecting the upper breathable layer, the breathable and impermeable sand layer and the lower breathable layer through needle punching to form an integral body, thus obtaining a breathable geosynthetic clay liner.

15. The production process of claim 14, wherein an adhesive layer is coated on an the surface of the lower breathable layer; and/or, a wool layer is laid on the surface of the upper breathable layer and/or the lower breathable layer.

16. The production process of claim 15, wherein the upper breathable layer is a breathable fiber cloth layer, and the lower breathable layer is a woven cloth layer or a non-woven fabric layer; and
the adhesive layer is environment-friendly glue.

17. The production process of claim 15, wherein, in the step 4), the upper breathable layer, the breathable and impermeable sand layer and the lower breathable layer are fixedly connected through needle punching with a hydrophobic thread to form an integral body, thus obtaining a breathable geosynthetic clay liner.

18. The production process of claim 14, wherein, in the step 4), the fiber of the upper breathable layer is brought to the lower breathable layer through needle punching, and fixed into the lower breathable layer.

19. The production process of claim 15, wherein, in the step 4), the fiber of the upper breathable layer is brought to the lower breathable layer through needle punching, and fixed by the adhesive layer coated on the lower breathable layer.

20. The production process of claim 15, wherein, in the step 1), the adhesive layer is coated on a rotating roller, and then the lower breathable layer is laid on the rotating roller and transported forward with the rotating roller, so that the adhesive layer is coated on a lower surface of the lower breathable layer.
